(19) United States
(12) Patent Application Publication
(10) Pub. No.: US 2004/0013842 A1
(43) Pub. Date: Jan. 22, 2004

(54) Machine and process for restoration of cinematographic films

(76) Inventor: Jean-Jacques Bougy, Garancieres (FR)

Correspondence Address: IP DEPARTMENT OF PIPER RUDNICK LLP, 3400 TWO LOGAN SQUARE, 18TH AND ARCH STREETS, PHILADELPHIA, PA, 19103, US

(21) Appl. No.: 10/380,015

(22) PCT Filed: Sep. 7, 2001
(86) PCT No.: PCT/FR01/02735

(30) Foreign Application Priority Data
Sep. 13, 2000 (FR) 00/11752

(51) Int. Cl. B32B 3/00

(52) U.S. Cl. 428/61

(57) ABSTRACT

The invention concerns a machine and a method for automatically restoring cinematographic films comprising connections produced by adhesive tapes, by unwinding the film in front of means (28) detecting the connections, stopping the unwinding, holding the film on either side of the detected connection with clips (30), cutting the film in the middle of the connection, eliminating the bits of adhesive tape, cleaning the film and fixing a new connection, then proceeding with the unwinding, eliminating with means (34) the overlapping lateral portions of the new connection and visually controlling the new connections with means (36). The invention enables to automatically restore films comprising connections consisting of adhesive tape.

The invention pertains to a machine and a process for the restoration of cinematographic films enabling notably replacement of the film-end splices that had been implemented by means of adhesive tape.

The adhesive tape used for implementing splices of cinematographic films, in particular 16-mm films, ages poorly and very quickly becomes, for example, dry and brittle or relatively greasy and dusty, which in practice makes projection impossible of older films containing this type of splice.

It is therefore necessary to carry out restoration of these films, a process presently performed manually by personnel who unwind each film, locate the splices and—being careful not to damage the film—eliminate the pieces of old adhesive tape, clean as carefully as possible the parts of the film that had been covered by adhesive tape, reconstitute the splice with pieces of new adhesive tape, perforate the splice in correspondence with the film's side perforations and possibly cut off the parts of adhesive tape that protrude laterally from the film.

This work is tedious, repetitive and extremely time consuming. Precautions are also required in handling the generally toxic solvents used to eliminate the old adhesives. Between 10 and 20 hours of labor are presently required to restore a length of film corresponding to one hour of projection. The 16-mm films containing adhesive tape splices which are presently archived in national institutes represent many tens of thousands of hours of projection. Their complete restoration would require at each institute more than a million hours of labor, thus a cost of more than 350 million francs over a time period estimated to be more than 30 years based on using a staff of around twenty full-time workers. It is thus obvious that such a program would be impossible to implement due to a lack of sufficient funding.

The goal of the present invention is notably to respond to this need.

The object of the invention is a machine for the restoration of cinematographic films containing adhesive tape splices, said machine enabling automatic elimination of the old splices and their replacement by new splices.

For this purpose the invention proposes a machine for restoration of cinematographic film containing splices formed of pieces of adhesive tape, characterized in that it comprises:

means for unwinding the film in front of splice detection means,

means for grasping the film on both sides of a detected splice,

means for cutting the film essentially in the middle of the splice,

means for eliminating the pieces of adhesive tape forming the splice,

means for cleaning the parts of the film previously covered by the pieces of adhesive tape, and

means for applying a new adhesive tape on the cleaned and joined parts of the film.

The machine according to the invention operates in a completely automatic manner and does not require the continuous intervention of an operator. A single operator can therefore monitor multiple machines and intervene on one or the other of these machines when necessary. The task of restoring a large number of films is thus greatly simplified and facilitated.

According to another characteristic of the invention, this machine comprises a first module formed by a frame bearing means for guiding a mobile carriage equipped at least with means for unwinding films and detecting splices and means for controlling displacement of the carriage, and a second independent, removable module comprising means for eliminating the splices and cleaning the film.

This layout separating the mechanical means of displacement and processing of the film from the chemical or other means used for the elimination of the pieces of adhesive tape and for the cleaning of the film, makes it possible if necessary to use different means for eliminating the splices and cleaning the film for different types of films and splices and thus to easily adapt the machine to different modes of restoration.

In a first mode of implementation of the invention, the means for eliminating the splices comprise means for the mechanical attack of the pieces of adhesive tape by spraying erosive microparticles such as, e.g., particles made of glass, starch, plastic or of water ice or dry ice.

In another mode of implementation of the invention, the means for eliminating the splices comprise means for the chemical attack of the pieces of adhesive tape with a solvent such as, e.g., trichloroethylene or methyl chloride.

The cleaning of the parts of the film previously covered by the pieces of adhesive tape is performed by means of a solvent of the same type by the spraying of the solvent on the film or by immersion of the film in a solvent bath. The action of the solvent on the film can optionally be reinforced by an ultrasound generator.

The cleaning can also be supplemented by a soft, nonaggressive brushing.

Drying of the cleaned parts of the film is then performed, e.g., by blowing hot air, then the cleaned parts of the film are joined and a new splice is implemented by a splicer of a suitable type which places pieces of adhesive tape on the joined parts of the film and forms the necessary perforations in the splice.

Means for automatically monitoring the film's side perforations can advantageously be provided on the machine for the detection of parts of the film where the perforations are damaged, destroyed or deformed, and which enable the possible intervention of an operator.

The invention also proposes a process for the restoration of cinematographic films containing splices formed by means of adhesive tape, this process being characterized in that it consists of:

detecting a splice optically, mechanically or electrically during the unwinding of the film,

stopping the unwinding of the film upon detection of a splice,

grasping the film at the splice level and transferring it successively to stations for cutting, eliminating the pieces of adhesive tape, cleaning and reconstitution of the splice by application of a new adhesive tape, and

restarting the unwinding of the film until detection of another splice.

The invention now makes possible the complete restoration of cinematographic films containing adhesive tape splices which are archived in large quantities in most of the countries of the world.

The invention will be better understood and its other characteristics, details and advantages will be made clear from the description below which is presented as an example with reference to the attached drawings in which:

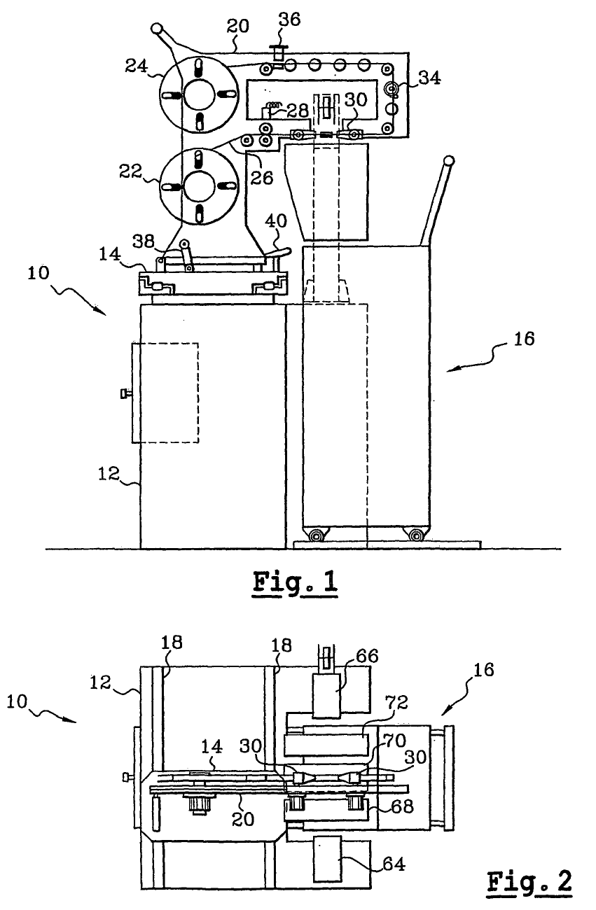

FIG. 1 is a schematic elevation view of a machine according to the invention,

FIG. 2 is a top view of the machine of FIG. 1,

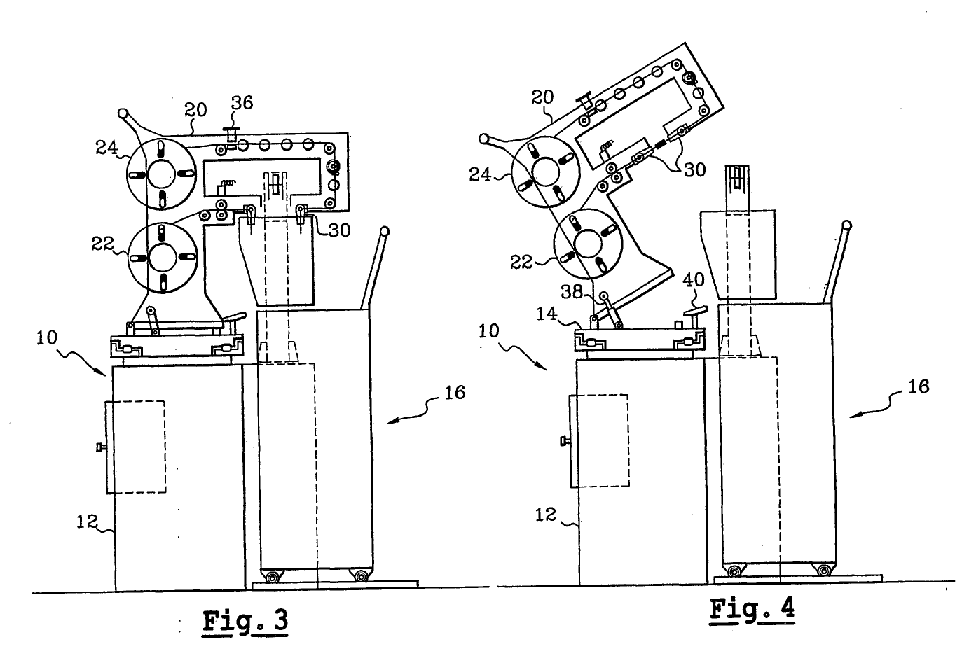

FIG. 3 is a view corresponding to FIG. 1 and representing the figure during a phase of elimination of a splice or cleaning or drying the parts of the film previously covered by the splice,

FIG. 4 is a view corresponding to FIGS. 1 and 3 but representing a part of the machine pushed aside for an intervention of the operator,

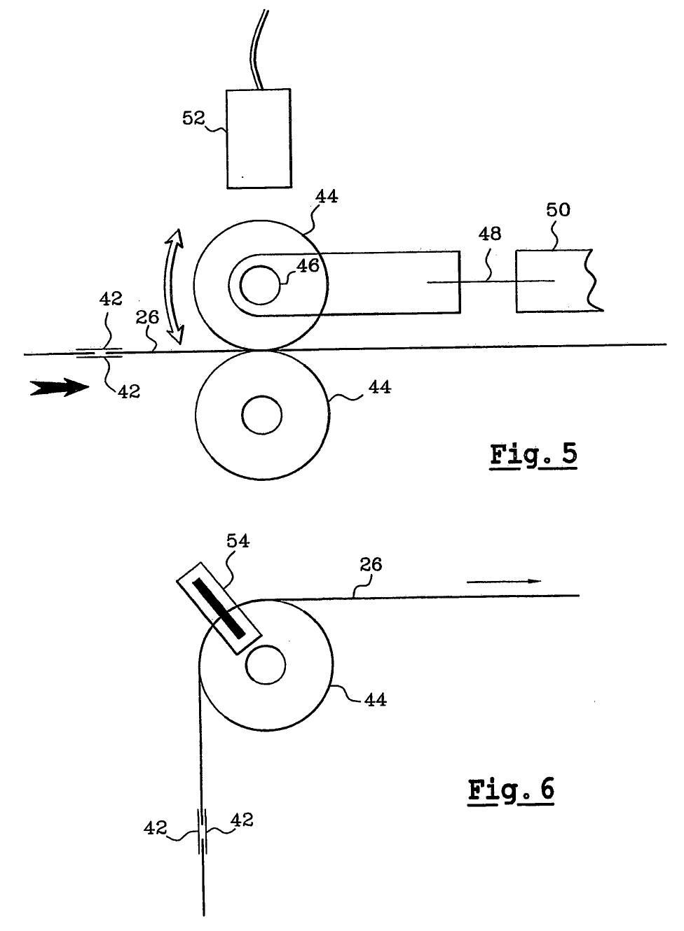

FIGS. 5 and 6 represent schematically two modes of implementation of means for detection of splices used in the machine according to the invention,

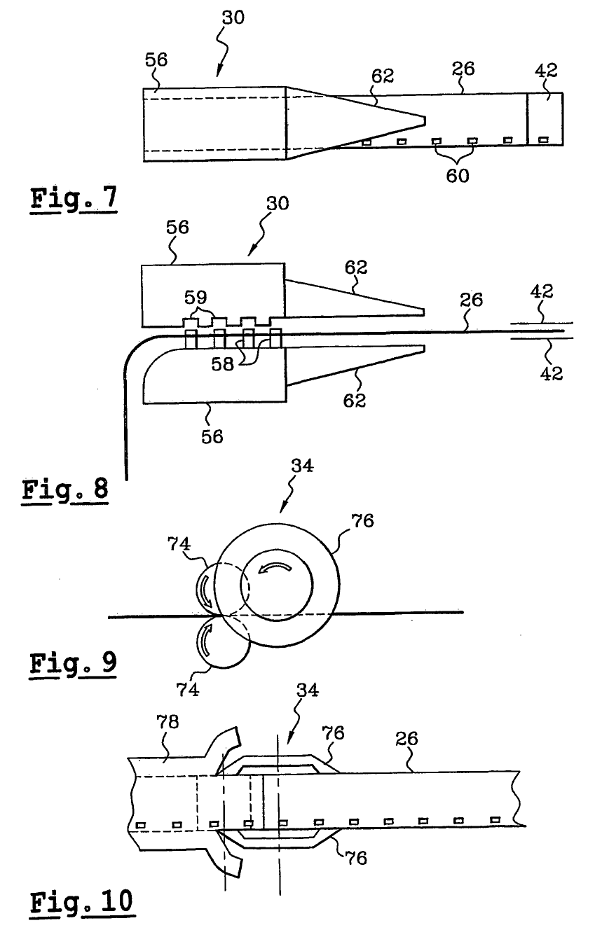

FIGS. 7 and 8 are top and elevation views respectively of means for grasping the film,

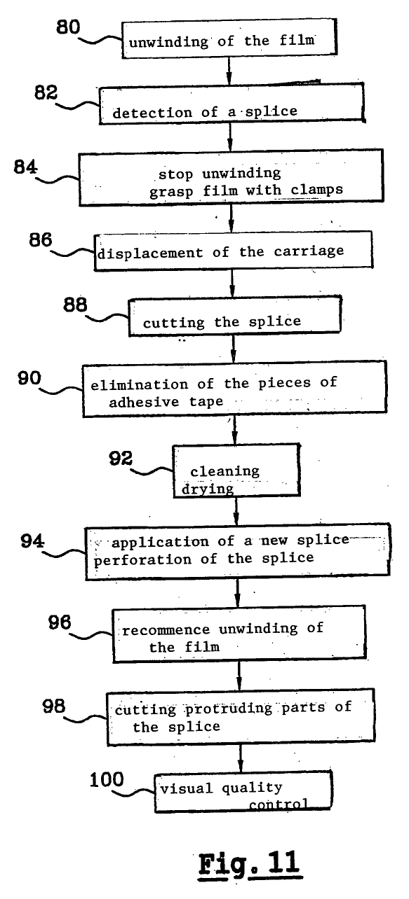

FIGS. 9 and 10 are elevation and top views respectively of means for cutting the protruding side walls of a new splice,

FIG. 11 is a flow chart of the principal operations of the process according to the invention.

The machine according to the invention, represented schematically in FIGS. 1 to 4, is more specifically intended for the restoration of 16-mm cinematographic films containing splices implemented by means of an adhesive tape such as, e.g., the tape marketed as J-LAR PERMACEL. These splices were created by placing an adhesive tape on both surfaces of the film, on both sides of the splicing line of the film lengths which are placed end to end, the width of these adhesive tapes being designed to cover exactly two images of the film. In a film of this type, which can have a single row of side perforations or two rows of side perforations, the replacement of the old splices by new splices must not degrade the film nor cause deterioration of the quality of the image or sound. The duration of the shots must be conserved so as to maintain the synchronization between the image and the sound. Consequently, any elimination of an image from a film end because of degradation of the film at this site must be accompanied by a replacement of this image by a black image.

The machine according to the invention comprises essentially a first module designated by reference 10 formed by a frame 12 and a mobile carriage 14 comprising a certain number of mechanical or electromechanical means which will be described in greater detail below, and a second module 16 which is independent of the first module 10 and which is mobile in relation to that module, this second module 16 comprising a certain number of film-processing means which can be modified or adapted to the nature of the films to be processed and of the splices to be replaced. Means which are not illustrated are provided to assure a precise positioning of the second module in relation to the first module and for immobilizing it in position.

The carriage 14 is mounted such that it is translationally mobile on the frame 10 by means of slides 18 and can be moved by motorized means comprising, e.g., a direct current geared motor and a clearance-free belt transmission.

The carriage 14 carries a platen 20 made, e.g., of a light alloy, positioned in a vertical plane and on which are mounted two motorized means for receiving a film take-off reel 22 and a film rewind reel 24 as well as a certain number of guiding rolls for the film 26 unwinding from the reel 22, these rolls defining an horizontal U-shaped loop terminating at the rewind reel 24 and passing through splice detection means 28, film grasping means 20, means 34 for lateral cutting of the new splices and means 36 for visual monitoring.

The platen 20 is articulated on the carriage 14 around a horizontal axis and can be manually pushed aside towards the exterior as show in FIG. 4 by the intervention of the operator, said pushing aside being facilitated by gas springs 38. The platen is 20 locked in its operating position on the carriage 14 by suitable means, e.g., by ratcheting means 40.

One mode of implementation of the splice detection means 28 is represented schematically in FIG. 5.

The presence of a splice formed by two pieces of adhesive tape 42 on the film 26 is manifested by a local excessive thickness of circa 8 to 10 μm on the film whose thickness is approximately 15 μm. The film is carried between two freely rotating rolls 44 one of which is mounted on a fixed axle and the other on an oscillating axle 46 articulated by means of a spring leaf 48 on an element 50 integral with the platen 20. The passage of the splice 42 between the rolls 44 is manifested by a displacement of the roll carried by the oscillating axis 46 towards a capacitative sensor 52 whose resolution is preferably less than 1 μm.

In the variant of implementation shown in FIG. 6, the film 26 passes over a freely rotating roll 44 mounted on a positionally fixed axle, laser scanning detection means 54 being provided to detect the radial position of a generatrix of the roll 44 over which the film 26 passes. Passage of the splice 42 over this generatrix causes an increase in the radial length detected by the laser scanning.

In both cases, suitable signal processing (detection of advancing edge, width and pulse amplitude) allow validation of the detection of a splice and stopping of the passage of the film when the splice is in a precise geometric position in which the film grasping means 30 can be locked on the film on both sides of the splice, this position being the position shown in FIG. 1.

In the example of implementation shown in FIGS. 7 and 8, these means 30 comprise pneumatically controlled clamps each constituted of two flat jaws 56 arranged on both sides of the film 26, with one of these jaws having teeth 58 on its surface facing the film 26 and designed to engage in the film's perforations 60. The other jaw 56 has, on its surface facing the film 26, cavities 60 designed to receive the ends of the previously mentioned teeth 58 upon locking of the clamp on the film 26.

The two jaws 56 are extended, on the side of the other clamp that is part of the means 30, by a pointed piece 62 extending parallel to the film 26 and along the film in the direction of the splice 42.

The jaws 56 of the film-grasping means 30 are mounted such that they can pivot on the platen 20 on horizontal axles so as to turn 90° downwards as shown schematically in FIG. 3 when the splice 42 located between the two previously mentioned clamps has been cut in half.

The cutting means 64 are mounted on the frame 12 in a transverse alignment with the grasping means 30 in relation to the platen 20 such that the translational movement of the carriage 14 on the slides 18 can bring the piece of film held between the clamps 30 to the level of the cutting means 64 so that the cutting means can implement a clean cut of the film and of the splice in the middle of the splice, i.e., just between the two film images connected by the pieces of adhesive tape 42. The cutting means 64 are known means, e.g., of the guillotine type.

The cutting means 64 are positioned on one branch of a U-shaped part of the frame 12, on the other branch of which is located the means 66 for applying a new splice on the film; these means 66 comprising notably a splicer of known type.

Between the branches of the U-shaped part of the frame 12 are positioned means for eliminating the pieces 42 of adhesive tape and for cleaning and drying the film, which are part of the second module 16 of the machine.

In a first form of implementation of the invention, the means 68 for elimination of the pieces of adhesive tape 42 comprise nozzles for spraying a solvent, such as trichloroethylene, that can dissolve the adhesive used in the old splice and thus unglue the pieces 42 of adhesive tape and wash them into a tank provided in the second module 16. For the elimination of these pieces of adhesive tape, the damps 30 are oriented vertically so as to allow the two parts of the film resulting from the cutting of the splice and bearing the pieces of adhesive tape 42 to hang downward. The spray nozzles are oriented essentially vertically downward such that the sprayed solvent can be collected with the pieces of adhesive tape in the storage tank of the second module 16.

Then, by moving the carriage 14, the parts of the film extending downwards from the clamps 30 are brought to the cleaning means 70 provided in the second module 16 and which comprise, e.g., a bath of the previously mentioned solvent in which the film parts are immersed. The cleaning action of the solvent can be reinforced by combination of an ultrasound generator with this solvent bath. Moreover, the cleaned film parts can be moved between soft brushes so as to eliminate by a gentle rubbing the adhesive possibly remaining on the film parts, without damaging these film parts.

Then, by a new movement of the carriage 14, the film parts held by the clamps 30 are brought to the drying means 72 comprising nozzles for blowing hot air.

After drying, the clamps turn 90° so as to return to their horizontal position in which they are oriented towards each other, the cleaned and dried cut parts of the film now being aligned essentially horizontally and placed end to end, which enables formation of a new splice by placing a piece of adhesive tape on each surface of the film in the previously mentioned means 66.

When the film splice has been reconstituted, perforations are formed in the new pieces of adhesive tape corresponding to the side perforations of the film 26.

As can be clearly seen in FIG. 2, the cutting means 64, the means 68 for eliminating the pieces of adhesive tape, the cleaning means 70, the drying means 72 and the means for applying a new splice 66 are independent of the platen 20 and aligned transversely in relation to it, the means for translational movement of the carriage 14 playing the role of means for transferring the film end held by the clamps 30 between the previously mentioned means 64, 68, 70, 72 and 66.

After a new splice has been applied by the means 66 and the necessary perforations have been implemented, the unwinding of the film recommences by driving the reels 22 and 24 in rotation until detection of another splice by the means 28.

The means 34 provided on the platen 20, an example of implementation of which is shown in FIGS. 9 and 10, allow elimination of the laterally protruding parts of the new splice formed on the film. These means 34 comprise two rolls 74 for guiding the film 26 and two rotary cutting blades 76 positioned along the edges of the film to eliminate the parts of the adhesive tapes 78 of the new splice that laterally protrude from the film 26.

The film then progresses to the visual quality control means 36 at which the unwinding is stopped when the new splice is in the field of vision of these quality control means. The operator can be alerted by a signal of any type when he must perform visual checking of the new splice. After this has been done, a local control, e.g., a push button, allows him to restart the unwinding of the film. When an old splice is detected by the means 28 before a new splice has reached the visual quality control means 36, the unwinding of the film is stopped for the replacement of the newly detected splice; unwinding is recommenced until the previously replaced splice reaches the visual quality control means 36.

Moreover, means for automatically monitoring the film's side perforations can be provided on the platen 20 to alert the operator to any anomalies found in these perforations and allow him to carry out repairs if necessary.

When the solvent used in the means for eliminating the pieces of adhesive tape and for cleaning is toxic, the tanks containing this solvent in the second module 16 have free surfaces and communication openings with the exterior atmosphere which are as small as possible. Whenever a tank is no longer being used, it is systematically closed by means of a tight seal. Moreover, localized aspiration means supported by the platen 20 enable extraction of the solvent vapors released by the open tanks in which are eliminated the pieces of adhesive tape and in which the film is washed.

In a second form of implementation of the invention, the pieces of adhesive tape are eliminated by mechanical attack means by spraying erosive microparticles on these pieces of tape. These microparticles can be particles made of glass, starch, plastic or of water ice or dry ice. The advantage of dry ice is its immediate evaporation after being sprayed on the pieces of tape to be eliminated.

A central control unit comprising data processing means (a microcomputer or a specific microprocessor card) is integrated in the frame 12 of the first module for controlling the machine's various film processing means.

FIG. 11 shows schematically the flow chart of the principal operations of the process according to the invention which comprises:

a film unwinding operation 80,

a splice detection operation 82,

an operation 84 comprising stopping the unwinding of the film and grasping the film by means of clamps 30 on both sides of the detected splice,

an operation 86 comprising moving the carriage 84 so as to bring the splice to the level of the cutting means 64,

an operation 88 comprising cutting the splice in its middle,

an operation 90 comprising eliminating the pieces of adhesive tape which, as previously described, can be performed by mechanical or chemical means,

an operation 92 comprising cleaning and drying the film parts previously covered by the pieces of adhesive tape,

an operation 94 comprising application of a new splice and perforation of this new splice,

an operation 96 comprising recommencement of the unwinding of the film,

an operation 98 comprising cutting the protruding parts of the splice, and

a visual quality control operation 100.

A supplementary operation of automatic monitoring of the perforations can optionally be performed between the previously mentioned operations 98 and 100.

The machines according to the invention can restore films automatically generally at a rate which is at least equal to that of an operator performing such restoration manually. When the operator supervises four machines and performs the necessary interventions on each of these machines, which is completely realistic in practice, use of the machines according to the invention allows a fourfold reduction in the time required for the restoration of a large number of films and an at least twofold reduction of the corresponding costs.

1. Machine for restoration of cinematographic film containing splices formed of pieces of adhesive tape, characterized in that it comprises:
means (22, 24) for unwinding the film in front of splice detection means (28),
means (30) for grasping the film on both sides of a detected splice,
means (64) for cutting the film essentially in the middle of the splice,
means (68) for eliminating the pieces of adhesive tape forming the splice,
means (70) for cleaning the parts of the film previously covered by the pieces of adhesive tape, and
means (66) for applying a new adhesive tape on the cleaned and joined parts of the film.

2. Machine according to claim 1, characterized in that it comprises means for controlling the unwinding of the film connected to the splice detection means (28) so as to stop the unwinding upon detection of a splice and to recommence the unwinding after elimination of the detected splice and application of a new splice.

3. Machine according to claim 1 or 2, characterized in that it comprises transfer means installed between the film unwinding means and the means for cutting (64), elimination (68), cleaning (70) and application of a new splice (66).

4. Machine according to one of the preceding claims, characterized in that it comprises a first module formed by a frame (12) bearing means (18) for guiding a mobile carriage (14) equipped at least with means for unwinding films and detecting splices and means for controlling displacement of the carriage (14), and a second independent, removable module (16) comprising the previously mentioned elimination means (68) and cleaning means (70).

5. Machine according to claim 4, characterized in that it comprises means for positioning and immobilizing the second module (16) on the first module.

6. Machine according to one of the preceding claims, characterized in that the means for eliminating the pieces of adhesive tape comprise means for mechanically attacking these pieces of tape by spraying erosive microparticles.

7. Machine according to claim 6, characterized in that the sprayed microparticles are microparticles made of glass, starch, plastic or of water ice or dry ice.

8. Machine according to one of claims 1 to 5, characterized in that the means (68) for eliminating the pieces of adhesive tape comprise means for the chemical attack of the adhesive tapes by a solvent, such as, e.g., trichloroethylene or methyl chloride.

9. Machine according to one of the preceding claims, characterized in that the cleaning means (70) comprise means for spraying a solvent or means for immersion in a solvent, optionally combined with an ultrasound generator and means for gentle, nonaggressive brushing.

10. Machine according to one of the preceding claims, characterized in that the cleaning means (72) also comprise means for drying the film, for example by blowing hot air.

11. Machine according to one of the preceding claims, characterized in that the means (66) for applying a new splice also comprise means for perforating the pieces of adhesive tape applied on the joined parts of the film.

12. Machine according to one of the preceding claims, characterized in that it also comprises means (34) for elimination of the protruding lateral parts of the new splice and means (36) for visual quality control of the new splices.

13. Process for the restoration of a cinematographic film containing splices formed by means of adhesive tape, characterized in that it consists of:
detecting a splice optically, mechanically or electrically during the unwinding of the film,
stopping the unwinding of the film upon detection of a splice,
grasping the film (26) at the splice level and transferring it successively to stations (64, 68, 70, 72, 66) for cutting, eliminating the pieces of adhesive tape, cleaning and reconstitution of the splice by application of a new adhesive tape, and
restarting the unwinding of the film until detection of another splice.
